(19) United States
(12) Patent Application Publication
(10) Pub. No.: US 2021/0075941 A1
(43) Pub. Date: Mar. 11, 2021

(54) Lens Driving Device, Camera Device and Electronic Apparatus

(71) Applicant: New Shicoh Motor Co., LTD, Zhejiang (CN)

(72) Inventor: Washio NORIYUKI, Zhejiang (CN)

(21) Appl. No.: 17/009,156

(22) Filed: Sep. 1, 2020

(30) Foreign Application Priority Data
Sep. 6, 2019 (CN) 201910846065.0

(51) Int. Cl. H04N 5/225; H04M 1/02; G02B 7/09

(52) U.S. Cl. CPC H04N 5/2254; H04N 5/2253; G02B 7/09; H04M 1/0264

(57) ABSTRACT

A lens driving device is disclosed that includes a first movable portion and a second movable portion, a fixed portion including a first fixed portion and a second fixed portion, and a supporting mechanism. The supporting mechanism includes two guide shafts that are fixed to the first fixed portion and the second fixed portion at both ends. The guide shafts extend in the optical axis direction and penetrate the first movable portion and the second movable portion. The supporting mechanism also includes a first spring member with one end fixed to the first fixed portion and the other end fixed to the first movable portion and a second spring member with one end fixed to the second fixed portion and the other end fixed to the second movable portion.

This application claims priority to Chinese patent application CN201910846065.0, filed on Sep. 6, 2019, the contents of which are incorporated by reference herein.

### TECHNICAL FIELD

The present disclosure relates to a lens driving device, a camera device and an electronic apparatus used in electronic apparatus such as smartphones.

### BACKGROUND

There is a camera device mounted on an electronic apparatus such as a smartphone or the like which includes a lens driving mechanism that plays an individual role such as for optical zoom and focus. As a document disclosing a technique related to this type of camera device, Japanese Laid-Open Patent Publication No. 2013-218751 (hereinafter referred to as “Patent Document 1”) can be given. The lens driving device described in Patent Document 1 is provided with a coil spring surrounding a guide member between a bearing portion and a stopper of a base, one guide member of a movable holder penetrating through the bearing portion, and the movable holder sliding in the X direction along two fixed shafts.

However, the technology in Patent Document 1 provides a configuration that holds the movable portion at a neutral position by an energizing force of the coil spring, but was difficult to be applied to a lens driving mechanism individually driving a plurality of movable portions that hold a plurality of lenses.

### SUMMARY

The present disclosure has been made in view of such problem, and an object of the present disclosure is to provide a lens driving device, a camera device, and an electronic apparatus capable of holding each movable portion at the neutral position in a system with a plurality of movable portions.

In accordance with a first aspect of the present disclosure, there is provided a lens driving device including: a first movable portion and a second movable portion, each having a lens holding portion that holds a lens with a common optical axis; a fixed portion having a first fixed portion and a second fixed portion that are arranged with the first movable portion and the second movable portion sandwiched therebetween and are opposed to each other in an optical axis direction; and a supporting mechanism, wherein, the first fixed portion and the first movable portion face each other, and the second fixed portion and the second movable portion face each other, the supporting mechanism includes: two guide shafts that are fixed to the first fixed portion and the second fixed portion at both ends, extend in the optical axis direction, and penetrate the first movable portion and second movable portion; a first spring member with one end fixed to the first fixed portion and the other end fixed to the first movable portion; and a second spring member with one end fixed to the second fixed portion and the other end fixed to the second movable portion.

In accordance with a second aspect of the present disclosure, there is provided a camera device including the lens driving device described above.

In accordance with a third aspect of the present disclosure, there is provided an electronic apparatus including the camera device described above.

### BRIEF DESCRIPTION OF THE DRAWINGS

FIG. 1 is a front view of a smartphone which is an electronic apparatus mounted with a camera device that includes a lens driving device, according to one embodiment of the present disclosure;

FIG. 2 is a perspective view of the camera device, which includes the lens driving device of FIG. 1;

FIG. 3 is an exploded perspective view of the lens driving device of FIG. 2;

FIG. 4 is a perspective view of the lens driving device of FIG. 2 viewed from another viewpoint; and

FIG. 5 is a view showing the internal structure of a case of the lens driving device of FIG. 4.

### DETAILED DESCRIPTION

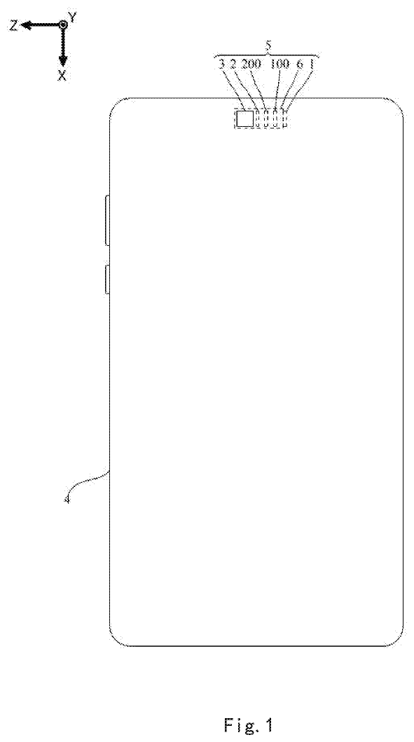

Hereinafter, embodiments of the present disclosure are explained with reference to drawings. As shown in FIG. 1, the camera device 5 is embedded in the housing of the smartphone 4. In the present embodiment, the camera device 5 is an optical element and includes: lens bodies 2, 200, and 100 with a common optical axis; an image sensor 1 that photoelectrically converts light guided from the subject through the lens bodies 2, 200, and 100; and a lens driving device 6 that holds the lens bodies 2, 200, and 100 and the image sensor 1 and drives the lens bodies 200 and 100 with respect to the image sensor 1. In the present embodiment, the camera device 5 further includes a prism 3, which is an optical element that bends the light from the subject and guides the light to the lens bodies 2, 200, and 100.

Hereinafter, the optical axis direction along the optical axis of the lens bodies 2, 200, and 100 is appropriately referred to as a Z direction, one direction orthogonal to the Z direction is appropriately referred to as an X direction, and a direction orthogonal to both the Z direction and the X direction is appropriately referred to as a Y direction. Further, the +Z side of the optical axis of the lens bodies 2, 200, and 100, which is side on which the prism 3 is located, may be referred to as a front side, and the −Z side, which is the side opposite to the prism 3 on which the image sensor 1 is provided, may be referred to as a rear side. Further, the +Y side may be referred to as an upper side, the −Y side may be referred to as a lower side, the +X side may be referred to as a left side, and the −X side may be referred to as a right side.

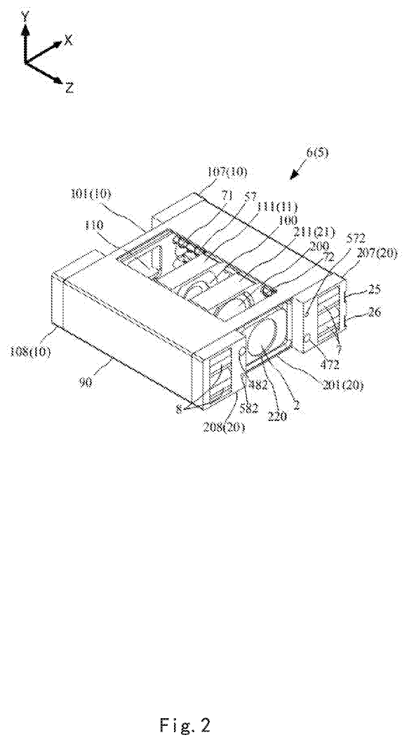

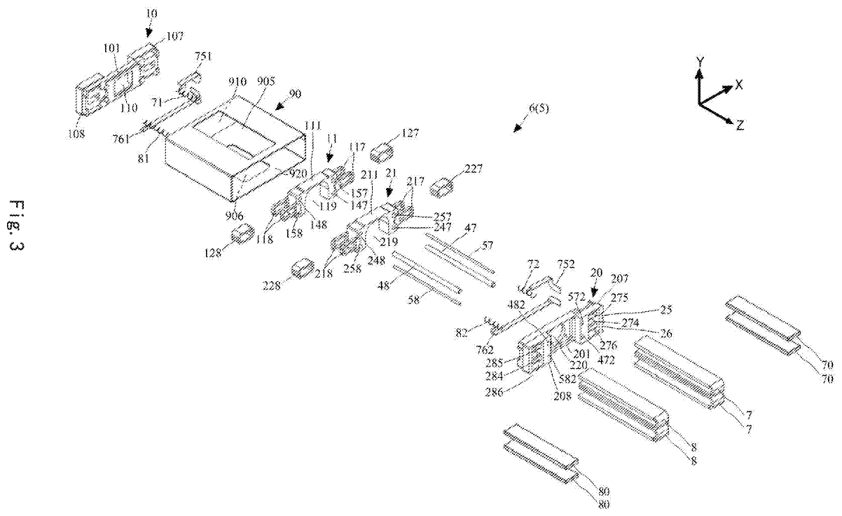

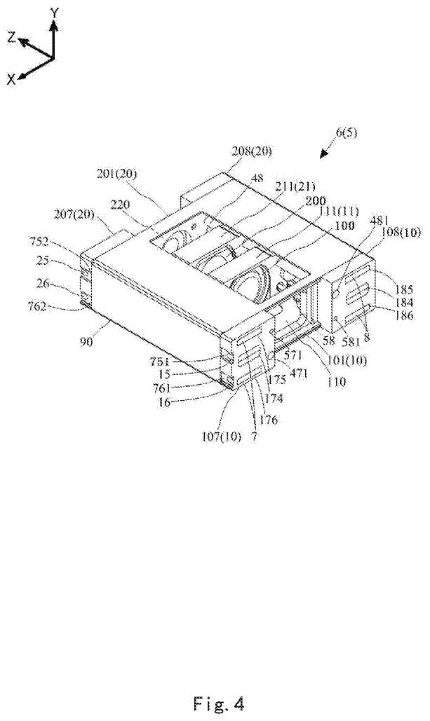

As shown in FIG. 2, FIG. 3, and FIG. 4, the lens driving device 6 accommodates a first movable portion 11, a second movable portion 21, a driving mechanism, a supporting mechanism, and a flexible printed substrate in a hollow rectangular parallelepiped case 90. The driving mechanism has two first driving coils 127 and 128, two second driving coils 227 and 228, two sets of driving magnets 70 and 80, and two sets of yokes 7 and 8. The supporting mechanism has two guide shafts 47 and 48, two auxiliary guide shafts 57 and 58, two first spring members 71 and 81, and two second spring members 72 and 82. The flexible printed substrate has a first FPC 751, a second FPC 761, a third FPC 752, and a fourth FPC 762. A first fixed portion 10 and a second fixed portion 20 serving as a fixed portion are fitted into openings 910 and 920 on the rear side and the front side of the case 90.

There is a rectangular opening 905 in the upper surface portion of the case 90. In in the lower surface of the case 90, there is a rectangular opening 906 smaller than the opening 905. As shown in FIG. 2 and FIG. 4, a convex surface 111 on the upper side of the first movable portion 11 and a convex surface 211 on the upper side of the second movable portion 21 are exposed from the opening 905 on the upper side of the case 90. A side surface of the lens body 100 accommodated in a lens holding portion 119 formed to be in a recessed shape toward the lower side of the first movable portion 11, and a side surface of the lens body 200 accommodated in a lens holding portion 219 formed to be in a recessed shape toward the lower side of the second movable portion 21 are exposed from the opening 906 on the lower side of the case 90.

The first fixed portion 10 and the second fixed portion 20 are arranged with the first movable portion 11 and the second movable portion 21 therebetween and are opposed to each other in the optical axis direction. As shown in FIG. 3, the first fixed portion 10 has an inner plate 101 with a rectangular opening 110 at the center thereof and two outer plates 107 and 108 provided on the left side and right side of the inner plate 101. The image sensor 1 is attached on the rear side of the opening 110.

As shown in FIG. 4, in a state where the first fixed portion 10 is fixed to the case 90, the inner plate 101 of the first fixed portion 10 is accommodated in the opening 910 of the case 90, and the outer plates 107 and 108 are exposed to the outside. Round holes 571 and 471 and square holes 175, 174, and 176 arranged in this order from the top are provided on the left side of the opening 110 of the first fixed portion 10, and round holes 481 and 581 and square holes 185, 184, and 186 arranged in this order from the top are provided on the right side. The inner diameters of the round holes 571 and 581 are smaller than the inner diameters of the round holes 471 and 481. The width of the square holes 175, 176, 185, and 186 in the Y direction is half of the width of the square holes 174 and 184 in the Y direction. Two notches 15 and 16 are provided on the left side surface of the outer plate 107.

As shown in FIG. 3, the second fixed portion 20 has an inner plate 201 with a circular opening 220 at the center, and outer plates 207 and 208 provided on the left side and the right side of the inner plate 201. The lens body 2 is fitted into the opening 220.

As shown in FIG. 2, in a state where the second fixed portion 20 is fixed to the case 90, the inner plate 201 of the second fixed portion 20 is accommodated in the opening 920 of the case 90, and the outer plates 207 and 208 are exposed to the outside. As shown in FIG. 3, round holes 572 and 472 and square holes 275, 274, and 276 arranged in this order from the top are provided on the left side of the opening 220 of the second fixed portion 20, and round holes 482 and 582 and square holes 285, 284, and 286 arranged in this order from the top are provided on the right side. The inner diameter of the round holes 472 and 482 is the same as the inner diameter of the round holes 471 and 481 of the first fixed portion 10. The inner diameter of the round holes 572 and 582 is the same as the inner diameter of the round holes 571 and 581. The width of the square holes 275, 276, 285, and 286 in the Y direction is half of the width of the square holes 274 and 284 in the Y direction. Two notches 25 and 26 are provided on the left side surface of the outer plate 207. Partitions separating the square holes 275 and 274, the square holes 274 and 276, the square holes 285 and 284, and the square holes 284 and 286 are recessed rearward from the front surfaces of the outer plates 207 and 208, and when the yokes 7 and 8 are inserted and attached to the square holes 275, 274, 276, 285, 284, and 286 from the front side of the second fixed portion 20, the front ends of the yokes 7 and 8 are coplanar with the front surfaces of the outer plates 207 and 208.

As shown in FIG. 3, four through holes 147, 148, 157, and 158 are bored in the first movable portion 11. Among the through holes 147, 148, 157, and 158, the through holes 147 and 148 are used for the guide shafts 47 and 48 to pass through, and the through holes 157 and 158 are used for the auxiliary guide shafts 57 and 58 to pass through. The through holes 147 and 148 have substantially the same diameter as that of the guide shafts 47 and 48, and one of them is a slightly longer hole in the direction connecting the through hole 147 and the through hole 148. The through holes 157 and 158 have a size such that the auxiliary guide shafts 57 and 58 does not come into contact with each other. The through holes 147 and 148 are located at positions away from each other in one diagonal direction across the center of gravity of the first movable portion 11, and the through holes 157 and 158 are located at positions away from each other in the other diagonal position across the center of gravity of the first movable portion 11, wherein the first movable portion 11 includes the lens body 100 and the first driving coils 127 and 128.

Two annular portions 117, which are attaching portions of the first driving coil 127, are formed so as to further protrude to the left side from the left front end portion and the left rear end portion of the main body of the first movable portion 11. Further, two annular portions 118, which are attaching portions of the first driving coil 128, are formed so as to further protrude to the right side from the right front end portion and right rear end portion of the main body of the first movable portion 11. The first driving coil 127 is accommodated and fixed between the two annular portions 117 on the left, and the first driving coil 128 is accommodated and fixed between the two annular portions 118 on the right. The first driving coil 127 is fixed such that its center hole is aligned with the center holes of the two annular portions 117, and the first driving coil 128 is fixed such that its center hole is aligned with the center holes of the two annular portions 118.

The second movable portion 21 has the same shape as the first movable portion 11. The second movable portion 21 is bored with four through holes 247, 248, 257, and 258. Among the through holes 247, 248, 257, and 258, the through holes 247 and 248 are used for the guide shafts 47 and 48 to pass through, and the through holes 257 and 258 are used for the auxiliary guide shafts 57 and 58 to pass through. The through holes 247 and 248 have substantially the same diameter as that of the guide shafts 47 and 48, and one of them is a slightly longer hole in the direction connecting the through hole 247 and the through hole 248. The through holes 257 and 258 have a size such that the auxiliary guide shafts 57 and 58 does not come into contact with each other. The through holes 247 and 248 are located at positions away from each other in one diagonal direction across the center of gravity of the first movable portion 21, and the through holes 257 and 258 are located at positions away from each other in the other diagonal position across the center of gravity of the second movable portion 21, wherein the second movable portion 21 includes the lens body 200 and the second driving coils 227 and 228.

The positions of the round holes 471, 481, 571, and 581 of the first fixed portion 10, the through holes 157, 148, 147, and 158 of the first movable portion 11, the through holes 257, 248, 247, and 258 of the second movable portion 21, and the round holes 572, 482, 472, and 582 of the second fixed portion 20 viewed from the Z direction are aligned respectively.

Two annular portions 217, which are attaching portions of the second driving coil 227, are formed so as to further protrude to the left side from the left front end portion and the left rear end portion of the main body of the second movable portion 21. Likewise, two annular portions 218, which are attaching portions of the second driving coil 228, are formed so as to further protrude to the right side from the right front end portion and the right rear end portion of the main body of the second movable portion 21. The second driving coil 227 of the driving mechanism is accommodated and fixed between the two annular portions 217 on the left, and the second driving coil 228 of the driving mechanism is accommodated and fixed between the two annular portions 218 on the right. The second driving coil 227 is fixed such that its center hole is aligned with the center holes of the two annular portions 217, and the second driving coil 228 is fixed such that its center hole is aligned with the center holes of the two annular portions 218.

The yokes 7 and 8 of the driving mechanism are magnetic bodies which attract the magnets. The yokes 7 and 8 have a shape formed by bending an elongated plate so that the shape viewed from the X direction is U-shaped. Each of the yokes 7 and 8 has two linear portions extending in parallel in the Z direction and a bottom portion connecting the linear portions. The driving magnets 70 and 80 of the driving mechanism are formed in a plate shape. The width in the X direction of the driving magnet 70 and 80 is approximately equal to the width in the X direction of the yokes 7 and 8, and the length in the Z direction of the driving magnets 70 and 80 is shorter than the length in the Z direction of the linear portions of the yokes 7 and 8.

Two yokes 7 and two yokes 8 are stacked in the up-down direction to form a set of yokes, respectively. The linear portions of the two yokes 7 forming the set are inserted from the outer side to the inner side of the square holes 275, 274, and 276 of the second fixed portion 20. The square hole 274 is inserted with a linear portion on the lower side of the upper yoke 7 and a linear portion on the upper side of the lower yoke 7. The linear portions of the two yokes 8 forming the set are inserted from the outer side to the inner side of the square holes 285, 284, and 286 of the second fixed portion 20. The square hole 284 is inserted with a linear portion on the lower side of the upper yoke 8 and a linear portion on the upper side of the lower yoke 8. The driving magnets 70 are arranged on the lower surface of the linear portion on the upper side of the upper yoke 7 and the upper surface of the linear portion on the lower side of the lower yoke 7, respectively. Furthermore, the driving magnets 80 are arranged on the lower surface of the linear portion on the upper side of the upper yoke 8 and the upper surface of the linear portion on the lower side of the lower yoke 8, respectively.

The tips of the linear portions of the yokes 7 are fitted in the square holes 175, 174, and 176 of the first fixed portion 10, and the tips of the linear portions of the yokes 8 are fitted in the square holes 185, 184, and 186 of the first fixed portion 10, respectively. Two linear portions of the yokes 7 are fitted in the square hole 174, and two linear portions of the yokes 8 are fitted in the square hole 184. The front end surfaces of the yokes 7 and 8 are coplanar with the rear surface of the first fixed portion 10. In this way, the yokes 7 and 8 also play a role of structural material. Two central linear portions in the up-down direction of the yokes 7 forming the set and two central linear portions in the up-down direction of the yokes 8 penetrate the first driving coils 127 and 128 and the second driving coils 227 and 228 together with the annular portions 117 and 118 of the first movable portion 11 and the annular portions 217 and 218 of the second movable portion 21.

At that time, the center holes of the first driving coils 127 and 128, the second driving coils 227 and 228, the annular portions 117 and 118, and the annular portions 217 and 218 are formed to be larger than the combined size of the two central linear portions in the up-down direction of the yokes 7 and 8. Thereby, the first movable portion 11 and the second movable portion 21 can move smoothly. Further, the driving magnets 70 and 80 are arranged with the central linear portions in the up-down direction of the yokes 7 and 8, the first driving coils 127 and 128, and the second driving coils 227 and 228 sandwiched therebetween. With this configuration, when the first driving coils 127 and 128 or the second driving coils 227 and 228 are supplied with electricity, an electromagnetic force is generated in the optical axis direction, respectively.

The two guide shafts 47 and 48 of the supporting mechanism are shafts having substantially the same diameter as the round holes 571 and 481 of the first fixed portion 10 and the round holes 472 and 482 of the second fixed portion 20. Further, the through holes 147 and 148 of the first movable portion 11 and the through holes 247 and 248 of the second movable portion 21 also have substantially the same diameter. The rear ends of the guide shafts 47 and 48 are inserted into the round holes 571 and 481 of the first fixed portion 10 and fixed with an adhesive, respectively, and the front ends of the guide shafts 47 and 48 are inserted into the round holes 472 and 482 of the second fixed portion 20 and fixed with an adhesive. The guide shafts 47 and 48 penetrate the through holes 147 and 148 of the first movable portion 11 and the through holes 247 and 248 of the second movable portion 21 and extend in the Z direction, which is the optical axis direction. Thus, the first movable portion 11 and the second movable portion 21 are supported by the guide shafts 47 and 48 so as to move freely in the optical axis direction. It is to be noted that, as described above, any one of the through holes 147 and 148 and any one of the through holes 247 and 248 become long holes, and in each movable portion, the guide shaft corresponding to the perfect circular hole is the main shaft, and the guide shaft corresponding to the long hole is the counter shaft.

The two auxiliary guide shafts 57 and 58 are shafts having substantially the same diameter as the round holes 571 and 581 of the first fixed portion 10 and the round holes 572 and 582 of the second fixed portion 20. The rear ends of the auxiliary guide shafts 57 and 58 are inserted into the round holes 471 and 581 of the first fixed portion 10 and fixed with an adhesive, and the front ends of the auxiliary guide shafts 57 and 58 are inserted into the round holes 572 and 582 of the second fixed portion 20 and fixed with an adhesive. The auxiliary guide shafts 57 and 58 are supported by the first fixed portion 10 and second fixed portion 20 at both ends, penetrate the through holes 157 and 158 of the first movable portion 11 and the through holes 257 and 258 of the second movable portion 21 and extend in the Z direction, which is the optical axis direction.

Two first spring members 71 and 81 let the auxiliary guide shafts 57 and 58 pass through centers thereof, and are interposed between the first fixed portion 10 and the first movable portion 11. Two second spring members 72 and 82 let the auxiliary guide shafts 57 and 58 pass through centers thereof, and are interposed between the second fixed portion 20 and the second movable portion 21.

The inner diameters of the first spring members 71 and 81 are large enough to such an extent that they do not contact the auxiliary guide shafts 57 and 58 in a natural length state. One ends of the first spring members 71 and 81 are fixed at positions near the edges of the round holes 471 and 581 in the first fixed portion 10, and the other ends of the first spring members 71 and 81 are fixed at positions near the edges of the through holes 157 and 158 in the first movable portion 11. In the present embodiment, one end of the first spring member 71 is electrically connected to the first FPC 751, and the other end is electrically connected to one end of the first driving coil 127. One end of the first spring member 81 is electrically connected to the second FPC 761, and the other end is electrically connected to one end of the first driving coil 128. In addition, the other end of the first driving coil 127 is electrically connected to the other end of the first driving coil 128. In this way, by using the parallel first spring members 71 and 81 for the electrical connection of the first driving coils 127 and 128, the electrical wiring is restrained only on the rear side of the lens driving device 6.

The inner diameters of the second spring members 72 and 82 are large enough to such an extent that they do not contact the auxiliary guide shafts 57 and 58 in a natural length state. One ends of the second spring members 72 and 82 are fixed at positions near the edges of the round holes 572 and 582 in the second fixed portion 20. The other ends of the second spring members 72 and 82 are fixed at positions near the edges of the through holes 257 and 258 in the second movable portion 21. In the present embodiment, one end of the second spring member 72 is electrically connected to the third FPC 752, and the other end is electrically connected to one end of the second driving coil 227. One end of the second spring member 82 is electrically connected to the fourth FPC 762, and the other end is electrically connected to one end of the second driving coil 228. In addition, the other end of the second driving coil 227 is electrically connected to the other end of the second driving coil 228. In this way, by using the parallel second spring members 72 and 82 for the electrical connection of the second driving coils 227 and 228, the electrical wiring is restrained only on the front side of the lens driving device 6.

The first FPC 751 extends along the upper surface of the outer plate 107 of the first fixed portion 10 in the X direction, and one end is bent downward at the left end of the outer plate 107 along the left surface of the outer plate 107 and has a shape in which the bent tip is extended to the rear side. The other end is bent downward along the front surface near the round hole 471. The second FPC 761 extends along the lower surfaces of the inner plates 101 and the outer plates 107 of the first fixed portion 10 in the X direction, is bent upward along the left surface of the outer plate 107, and has a shape in which the bent tip is extended to the rear side. The opposite side is bent upwards along the front surface near the round hole 581.

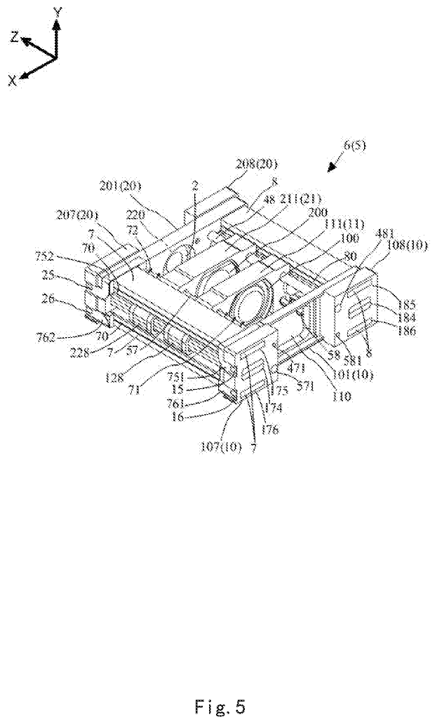

The first FPC 751 is joined to the upper surface of the outer plate 107 of the first fixed portion 10. As shown in FIG. 4 and FIG. 5, a portion extending to the rear side of one end of the first FPC 751 is fixed to the notch 15 of the first fixed portion 10, and this portion is exposed to the outside. The other end of the first FPC 751 is electrically connected to the first spring member 71.

The second FPC 761 is joined to the lower surfaces of the inner plate 101 and the outer plate 107 of the first fixed portion 10. As shown in FIG. 4 and FIG. 5, a portion extending to the rear side of one end of the second FPC 761 is fixed to the notch 16 of the first fixed portion 10, and this portion is exposed to the outside. The other end of the second FPC 761 is electrically connected to the first spring member 81.

The third FPC 752 and the fourth FPC 762 have a shape symmetrical with the first FPC 751 and the second FPC 761 with respect to the XY plane. The third FPC 752 is joined to the upper surface of the outer plate 207 of the second fixed portion 20. As shown in FIG. 4 and FIG. 5, a portion extending to the front side of one end of the third FPC 752 is fixed to the notch 25 of the second fixed portion 20, and this portion is exposed to the outside. The other end of the third FPC 752 is electrically connected to the second spring member 72.

The fourth FPC 762 is joined to the lower surfaces of the inner plate 201 and the outer plate 207 of the second fixed portion 20. As shown in FIG. 4 and FIG. 5, a portion extending to the front side of one end of the fourth FPC 762 is fixed to the notch 25 of the second fixed portion 20, and this portion is exposed to the outside. The other end of the fourth FPC 762 is electrically connected to the second spring member 82.

The portions of the first FPC 751 and the second FPC 761 that are fixed to the notches 15 and 16 of the first fixed portion 10 and exposed to the outside, and portions of the third FPC 752 and the fourth FPC 762 that are fixed to the notches 25 and 26 of the second fixed portion 20 and exposed to the outside are electrically connected to the substrate of the smartphone 4. The electric current returns from the substrate of the smartphone 4 through the first FPC 751, the first spring member 71, the first driving coil 127, the first driving coil 128, the second spring member 81, and the second FPC 761 to the substrate of the smartphone 4, for example. Furthermore, the electric current returns from the substrate of the smartphone 4 through the third FPC 752, the second spring member 72, the second driving coil 227, the second driving coil 228, the second spring member 82, and the fourth FPC 762 to the substrate of the smartphone 4.

In a state where no electric current is supplied to the first driving coils 127 and 128, the first movable portion 11 is located at a position (hereinafter referred to as the neutral position) away from the first fixed portion 10 toward the second fixed portion 20 by a distance corresponding to the natural length of the first spring members 71 and 81. In a state where no electric current is supplied to the second driving coils 227 and 228, the second movable portion 21 is located at a position (hereinafter referred to as the neutral position) away from the second fixed portion 20 toward the first fixed portion 10 by a distance corresponding to the natural length of the second spring members 72 and 82.

When an electric current flows through the first driving coils 127 and 128, due to an electromagnetic action between the first driving coils 127 and 128 and the driving magnets 70 and 80, a thrust force in the Z direction is generated, and the first movable portion 11 moves in the Z direction against the energizing force of the first spring members 71 and 81. When the electric current supplied to the first driving coils 127 and 128 is stopped, the first movable portion 11 returns to the neutral position due to the restoring force of the first spring members 71 and 81. Furthermore, when an electric current flows through the second driving coils 227 and 228, due to an electromagnetic action between the second driving coils 227 and 228 and the driving magnets 70 and 80, a thrust force in the Z direction is generated, and the second movable portion 21 moves in the Z direction against the energizing force of the second spring members 72 and 82. When the electric current supplied to the second driving coils 227 and 228 is stopped, the second movable portion 21 returns to the neutral position due to the restoring force of the second spring members 72 and 82.

The above is the details of the present embodiment. According to the present embodiment, the lens driving device 6 includes: a first movable portion 11 and a second movable portion 21 respectively having lens holding portions 119 and 219 that hold lens bodies 100 and 200 with a common optical axis; a fixed portion having a first fixed portion 10 and a second fixed portion 20 that are arranged with the first movable portion 11 and the second movable portion 21 sandwiched therebetween and are opposed to each other in the optical axis direction; and a supporting mechanism. The first fixed portion 10 and the first movable portion 11 face each other, and the second fixed portion 20 and the second movable portion 21 face each other. The supporting mechanism includes: two guide shafts 47 and 48 that are fixed to the first fixed portion 10 and the second fixed portion 20 at both ends, extend in the optical axis direction and penetrate the first movable portion 11 and the second movable portion 21; the first spring members 71 and 81 with one end fixed to the first fixed portion 10 and the other end fixed to the first movable portion 11; and the second spring members 72 and 82 with one end fixed to the second fixed portion 20 and the other end fixed to the second movable portion 21. Thereby, the first movable portion 11 can be held at the neutral position by the first spring members 71 and 81, and the second movable portion 21 can be held at the neutral position by the second spring members 72 and 82. Therefore, according to the present embodiment, it is possible to provide a lens driving device 6, a camera device 5, and an electronic apparatus capable of holding each movable portion at the neutral position in a system with a plurality of movable portions.

The natural lengths of the first spring members 71 and 81 and the second spring members 72 and 82, that is, the respective neutral positions, may be freely designed. The balance is considered among the roles of the lens bodies 100 and 200, the necessary strokes, and the spring constants, the lengths and the thrust force of the first spring members 71 and 81 and the second spring members 72 and 82 and the like.

It is to be noted that, the first spring members 71 and 81 may be inserted between the first fixed portion 10 and the first movable portion 11, the second spring members 72 and 82 may be inserted between the second movable portion 21 and the second fixed portion 20, and the third spring member may be inserted between the first movable portion 11 and the second movable portion 21. The first movable portion 11 and the second movable portion 21 may thus be held at the neutral position by balance of these three spring members.

In addition, a set of auxiliary guide shafts and two sets of spring members may be further added. The first movable portion 11 is connected to the first fixed portion 10 via the first spring members 71 and 81, and is connected to the second fixed portion 20 via a set of first additional spring members. At this time, the second movable portion 21 is further provided with large through holes for the first additional spring members to pass through. The auxiliary guide shaft 57 passes through the center holes of the first spring member 71 and one of the first additional spring members, and the auxiliary guide shaft 58 passes through the center holes of the first spring member 81 and the other one of the first additional spring members. The second movable portion 21 is connected to the second fixed portion 20 via the second spring members 72 and 82, and is connected to the first fixed portion 10 via a set of second additional spring members. At this time, the first movable portion 11 is further provided with large through holes for the first additional spring members to pass through. One of the two additional auxiliary guide shafts passes through the center holes of the second spring member 72 and one of the second additional spring members, and the other one of the two additional auxiliary guide shafts passes through the center holes of the second spring member 82 and the other one of the second additional spring members.

In the above embodiment, it is possible to support the first movable portion 11 and the second movable portion 21 by only two guide shafts 47 and 48 bridged between the first fixed portion 10 and the second fixed portion 20 without providing the auxiliary guide shafts 57 and 58. At that time, the first spring members 71 and 81 may be fixed to the first movable portion 11 and the first fixed portion 10 with the guide shafts 47 and 48 passing through the centers thereof, and the second spring members 72 and 82 may be fixed to the second movable portion 21 and the second fixed portion 20 with the guide shafts 47 and 48 passing through the centers thereof. Alternatively, those members may be fixed to the first movable portion 11 and the first fixed portion 10 and the second movable portion 21 and the second fixed portion 20 with nothing passing through the centers of the first spring members 71 and 81 and the second spring members 72 and 82.

Furthermore, in the above embodiment, the first spring members 71 and 81 and the second spring members 72 and 82 may be plate springs instead of coil springs. The plate spring is configured with an outer side portion fixed to the first fixed portion 10, an inner side portion fixed to the first movable portion 11, and a plurality of arm portions connecting the outer side portion and the inner side portion. The plate spring that connects the second fixed portion 20 and the second movable portion 21 can also have the same configuration. Furthermore, a plurality of movable portions including the first movable portion 11 and the second movable portion 21 and the fixed portion may be connected by such a plate spring.

Further, in the above embodiment, the direction of separation of the through hole 147 and the through hole 148 and the direction of separation of the through holes 247 and 248 may be different from the diagonal direction. For example, the through hole 147 and the through hole 148 of the first movable portion 11 may be at positions away from each other in the X direction with the center of gravity of the first movable portion 11 therebetween, and the through holes 247 and 248 of the second movable portion 21 may be at positions away from each other in the X direction with the center of gravity of the second movable portion 21 therebetween.

Furthermore, in the above embodiment, in order to reduce the friction between the through holes 147, 148, 247, and 248 and the guide shafts 47 and 48 therein, lubricant may be provided between the inner peripheral surfaces of the through holes 147, 148, 247, and 248 and the outer peripheral surfaces of the guide shafts 47 and 48. Further, the inner peripheral surfaces of the through holes 147, 148, 247, and 248 and the outer peripheral surfaces of the guide shafts 47 and 48 may be polished so as to be smooth. Furthermore, the through holes 147, 148, 247, and 248 and the guide shafts 47 and 48 may be formed by combining different materials. For example, the through holes 147, 148, 247, and 248 may be formed of iron, and the guide shafts 47 and 48 may be formed of another metal (for example, stainless steel). Furthermore, the through holes 147, 148, 247, and 248 may be formed of resin, and the guide shafts 47 and 48 may be formed of metal.

Moreover, although an element having a reflecting surface such as the prism 3 is arranged on the front side of the second fixed portion 20, it may not be arranged. Furthermore, the hand shake correction may be corrected by moving the image sensor 1 in a direction orthogonal to the optical axis or rotating the image sensor 1 about the optical axis. Furthermore, another lens body may be arranged between the lens body 100 and the image sensor 1.

Moreover, in the present embodiment, it is described a configuration in which the case 90 is sandwiched between the first fixed portion 10 and the second fixed portion 20, but the outer dimensions of one of the first fixed portion 10 and the second fixed portion 20 may be slightly smaller than the dimensions of the openings 910 and 920 so that the case 90 can be mounted at the end of assembly. The driving mechanism may be only arranged on any one of the left and right sides instead of the both sides.

What is claimed is:

1. A lens driving device comprising:
a first movable portion and a second movable portion, each with a lens holding portion that holds a lens having a common optical axis;
a fixed portion comprising a first fixed portion and a second fixed portion that are arranged with the first movable portion and the second movable portion sandwiched there between and are opposed to each other in an optical axis direction; and
a supporting mechanism,
wherein the first fixed portion and the first movable portion face each other, the second fixed portion and the second movable portion face each other, and
the supporting mechanism comprises:
two guide shafts that are fixed to the first fixed portion and the second fixed portion at both ends, wherein the two guide shafts extend in the optical axis direction and penetrate the first movable portion and second movable portion;
a first spring member with one end fixed to the first fixed portion and the other end fixed to the first movable portion; and
a second spring member with one end fixed to the second fixed portion and the other end fixed to the second movable portion.

2. The lens driving device according to claim 1, wherein the first spring member and the second spring member are coil springs.

3. The lens driving device according to claim 2, wherein the first spring member and the second spring member are fixed with the two guide shafts passing through centers thereof, respectively.

4. The lens driving device according to claim 2, further comprising:
two auxiliary guide shafts that are fixed at different positions from positions where the two guide shafts are fixed in the first fixed portion and the second fixed portion, extend in the optical axis direction, and penetrate the first movable portion and second movable portion,
wherein the first spring member and the second spring member are fixed with the auxiliary guide shafts passing through centers thereof, respectively.

5. The lens driving device according to claim 1, wherein the two guide shafts pass through holes at positions opposed to each other across center of gravity in each of the first movable portion and the second movable portion.

6. The lens driving device according to claim 4, wherein the two auxiliary guide shafts pass through holes at positions opposed to each other across center of gravity in each of the first movable portion and the second movable portion.

7. The lens driving device according to claim 1, further comprising a driving mechanism, wherein:
the driving mechanism comprises:
a first driving coil and a second driving coil attached to attaching portions of the first movable portion and the second movable portion;
a yoke that is formed in a U-shape with two linear portions to attach the first fixed portion and the second fixed portion; and
a driving magnet attached to one linear portion of the yoke, and
the other linear portion of the yoke penetrates center holes of the first driving coil and the second driving coil together with the attaching portions provided in the first movable portion and the second movable portion, respectively.

8. The lens driving device according to claim 1, further comprising:
a first driving coil attached to the first movable portion and a second driving coil attached to the second movable portion, wherein:
two first spring members and two second spring members are provided,
one end of the first driving coil is electrically connected to the other end of one of the first spring members, the other end of the first driving coil is electrically connected to the other end of the other one of the first spring members, and one ends of the two first driving coils are electrically connected to outside of the device on a side of the first fixed portion, and
one end of the second driving coil is electrically connected to the other end of one of the second spring members, the other end of the second driving coil is electrically connected to the other end of the other one of the second spring members, and one ends of the two second driving coils are electrically connected to outside of the device on a side of the second fixed portion.

9. A camera device comprising the lens driving device according to claim 1.

10. An electronic apparatus comprising the camera device according to claim 9.
